(19) United States
(12) Patent Application Publication
(10) Pub. No.: US 2022/0052996 A1
(43) Pub. Date: Feb. 17, 2022

(54) METHODS FOR BIOMETRIC VERIFICATION USING A MOBILE DEVICE

(71) Applicant: PRECISE BIOMETRICS AB, Lund (SE)

(72) Inventors: Fredrik Sjöholm, Lund (SE); Tom Söberg, Dalum (SE)

(73) Assignee: PRECISE BIOMETRICS AB, Lund (SE)

(21) Appl. No.: 17/309,675

(22) PCT Filed: Dec. 13, 2019
(86) PCT No.: PCT/EP2019/085135

§ 371 Date: Jun. 14, 2021

(30) Foreign Application Priority Data
Dec. 20, 2018 (SE) 1851630-2

(51) Int. Cl. H04L 29/06; G06K 9/00

(52) U.S. Cl. CPC H04L 63/0861; H04L 2463/082; G06K 9/00288

(57) ABSTRACT

A method (200) for registering a new account of a user of a verification software by using a mobile device (108) equipped with a camera (110) and a display (112). The method (200) may comprise capturing (202) a first image of a front side (702) of a physical ID card (700) by using the camera (110), wherein the physical ID card (700) comprises a text (704), comprising user information, and an ID photo (706) depicting the user's face, extracting (204) the user information from the text (704) and ID face features from the ID photo (706), presenting (206) the user information to the user on the display (112), capturing (208) a reference photo of the user's face by using the camera (110), extracting (210) reference face features from the reference photo, comparing (212) the reference face features and the ID face features, if a match (214) is found, forming (216) a face template by using the reference face features and storing (218) the face template together with the user information.

### TECHNICAL FIELD

The present patent application generally relates to biometric verification. More particularly, it is presented a method for registering a new account of a verification software, a method for using a registered account of a verification software, and a method for verifying the identity of a user, and devices thereof.

### BACKGROUND ART

Today, it is commonly known to use different types of software solutions for verify a user's identity. A well-known solution, commonly used in Sweden, is the verification software application called mobile bank ID. This solution is connected to and verified via the user's bank. To register a mobile bank ID, the user needs to download the software application to a mobile device and usually the user also must visit the bank office or using a hardware token to complete the registration. When the user replaces his or her mobile device with a new device, registration has to be made once again for the new device, which means that the user has to visit the bank office or use the hardware token that has been provided by the user's bank. An advantage with using the mobile bank ID is that the user can verify its identity in a quick and easy way without using a physical ID card.

A drawback is however, in addition to the circumstantial registration process, that the user verifies his or her identity with the hardware token by using a PIN code. Using a PIN code is for many reasons not a secure solution, even if combined with the hardware token. As a consequence, in addition to a cumbersome registration process, there is a risk that someone else can get access to this critical data and in turn use someone else's identity.

In a digital onboarding toolkit provided by the company Innovatrics, it has been presented that the onboarding of new customers can be made in three steps, taking a picture of a user's ID document, confirming user data extracted from the ID document and verifying an identity by taking a selfie and comparing the selfie with a face of the ID document.

Even if it today exists easy ways to verify the identity when creating a new account, there is a need to make the communication between a bank and the user even more convenient for both parties without compromising on security.

For this reason, there is a need for a method related to how to register a user of a verification software in an easy and secure way. Further, there is also a need for a method related to how to use the verification software after a registration has been conducted.

### SUMMARY

It is an object to at least partly overcome one or more of the above-identified limitations of the prior art. In particular, it is an object to provide a method that is relying on biometric verification instead of PIN code verification.

It has been realized by the inventors that user information and a photo provided on a physical ID card can be used when registering a new account in order to be able to provide a both expedient and secure registration process.

According to a first aspect it is provided a method for registering a new account of a user of a verification software by using a mobile device equipped with a camera and a display. The method may comprise:

capturing a first image of a front side of a physical ID card by using the camera, wherein the physical ID card comprises a text, comprising user information, and an ID photo depicting the user's face;

extracting the user information from the text and ID face features from the ID photo;

presenting the user information to the user on the display;

capturing a reference photo of the user's face by using the camera;

extracting reference face features from the reference photo;

comparing the reference face features and the ID face features;

if a match is found, forming a face template by using the reference face features; and

storing the face template together with the user information.

An advantage is that a risk that someone else than the user, that is a legitimate physical ID card holder, is registering the account can be reduced.

A further advantage is that registering the new account can be made not only reliably, but also quickly and without requiring special hardware, such as hardware tokens.

The step of forming the face template may further comprise using both the reference face features and the ID face features.

An advantage of using the ID face features not only for verifying that the user of the mobile device is the user being depicted on the physical ID card, but also for forming the face template is that this is based on face features from two different photos of the user's face.

The method may further comprise verifying an identity of the user, within a pre-set time period after the face template has been stored, by capturing a verification photo of the user's face by using the camera, extracting verification face features from the verification photo, comparing the verification face features with template face features of the face template, and if a match is found, authenticate the account for face recognition login.

The method may further comprise requesting the user to follow a graphical object with his or her eyes, presented on the display, wherein the graphical object is moving according to a predetermined way, capturing eye movement image data depicting eye movements of the user, comparing the eye movement image data with eye movement reference data based on the predetermined way the graphical object was moved, and if the eye movement data correspond to the eye movement reference data, identifying the user as a real person.

The method may further comprise, capturing an additional verification information comprising biometrical information of the user by using the mobile device, extracting additional biometric features from the additional verification information, forming an additional biometric template by using the additional biometric features, and storing the additional biometric template together with the face template and the user information.

The additional verification information may comprise fingerprint image data.

The mobile device may be equipped with a microphone.

The additional verification information may further comprise a voice sample of the user captured by using the microphone.

The method may further comprise capturing a second image of a back side of the physical ID card.

The user information and the face template may be stored in a cloud computer, wherein the step of comparing the reference face features and the ID face features may be performed in the cloud computer.

According to a second aspect it is provided a method for using a registered account of a user of a verification software, the method may comprise:

starting the verification software, thereby setting the verification software in a first state;

requesting the user to log in to a second state of the verification software by capturing a sample photo of the user's face by using a camera of a mobile device;

extracting sample face features from the sample photo;

comparing the sample face features with template face features of a face template linked to the registered account;

if a match may be found, authorizing the user to the second state of the verification software.

The face template may be created according to the first aspect.

The method may further comprise receiving user input regarding actions to be performed, requesting the user to confirm the actions to be performed, capturing additional sample information of the user, comparing the additional sample information with an additional biometric template, and if a match is found, performing the selected actions.

The additional biometric template may be formed according to the first aspect.

According to a third aspect it is provided a method for verifying identity of a user of a verification software by using a mobile device equipped with a camera and a display, the method may comprise:

determining position data for the mobile device;

identifying a landmark based on the position data;

requesting the user to capture a landmark sample photo depicting a face of the user and the landmark by using the camera;

extracting landmark sample face features from the landmark sample photo;

comparing the landmark sample face features with face template features of a face template, wherein the comparison is performed in a first server;

comparing the landmark depicted in the landmark sample photo with a landmark template, wherein the comparison is performed in a second server; and

if two matches may be found, verifying the identity of the user.

The comparison between the face depicted in the sample and the face template may be based on activity data.

An advantage obtained, by using activity data when comparing the face depicted in the sample and the face template, may be that different templates based on the activity of the user can be used when performing the comparison. For instance, if a user has been running, the user may have reddish face and sweaty fingers, based on this, a face template linked to high physical activity may be chosen by the verification software.

The landmark template may be based on the time of the day.

The first server may be a secure database comprising user information and face templates.

The second server may be a non-restricted database.

The method may further comprise determining weather conditions, GPS-coordinates and the time of the day, based on the position data.

The method may further comprise activity data based on GPS data or data from a training app.

According to a fourth aspect it is provided a mobile device which may comprise:

a camera configured to capture a sample of biometric features of a user;

a display configured to present information for the user;

a microphone configured to capture a sample of voice features of the user;

a memory holding template features coupled to a template for the user, wherein the template is an image of a biometric sample of an authorized user, text, comprising user information of the authorized user, and a photo depicting the authorized user's face;

a processor configured to extract sample features from the sample, retrieve the template features from the memory, compare the sample features with the template features, and if a match between the sample features and the template features is found, accepting a login to a verification software for the authorized user.

Further, mobile devices similar to the fourth aspect may also be provided that are configured to perform the steps of any of the aspects presented above.

### BRIEF DESCRIPTION OF THE DRAWINGS

Embodiments will now be described, by way of example, with reference to the accompanying schematic drawings, in which

FIG. 1 illustrates an overview of different states of a verification software.

FIG. 2 illustrates a flow chart for a method for registering a new account of a user of a verification software.

FIG. 3 illustrates a flow chart for a method for using a registered account of a user of a verification software.

FIG. 4 illustrates a flow chart for a method for verifying identity of a user of a verification software.

FIG. 5 generally illustrates a cloud computer environment.

FIG. 6 generally illustrates the mobile device.

FIG. 7 generally illustrates the physical ID card.

FIG. 8a-h illustrates an example of using the method for registering a new account of a user of a verification software.

FIG. 9a-g illustrates an example of using the method for using a registered account of a user of a verification software.

### DETAILED DESCRIPTION

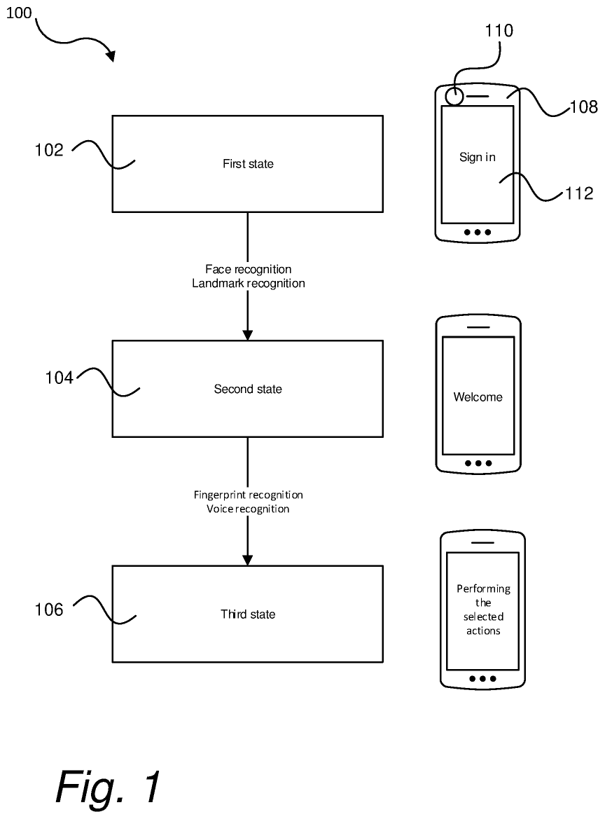

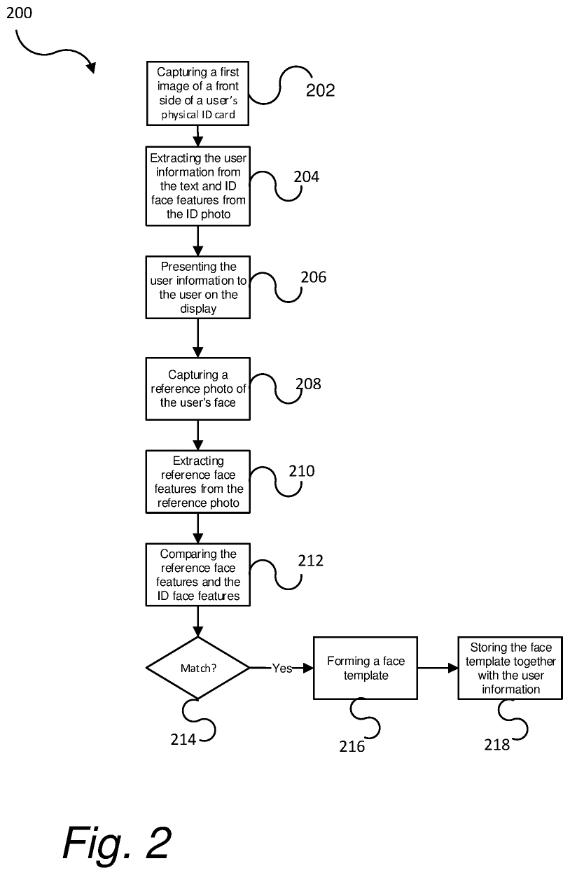

With reference to FIG. 1, an overview of different states of a verification software 100 is generally illustrated by way of example.

In this particular example, the verification software comprises a first, a second and a third state 102, 104, 106. The three states 102, 104, 106 can identify different security levels of the verification software. The first state may have a lowest security level, wherein no verification of the user has been performed.

The verification software can be used in combination with a mobile device 108. The mobile device 108 may be equipped with a camera 110 and a display 112.

In the first state 102, a first view of the verification software may be presented to a user. In this first state 102, the user may be requested to log in to the second state 104 of the verification software by capturing a sample photo of the user's face by using the camera 110.

If sample face features extracted from the sample photo correspond to template face features of a face template, the user may be authorized, i.e. registered as the user linked to a registered account. After having verified the user, the verification software 100 can switch from the first state 102 to the second state 104. The face template being used for user verification may have been formed when the user created the account of the verification software and may be stored on a server.

If the user is not authorized, i.e. not recognized as the user with the registered account, the verification software may proceed with another method for verifying the identity of the user. The user may for instance be requested to capture a landmark sample photo depicting the face of the user and a predetermined landmark linked to position data for the mobile device 108, by using the camera 110.

If landmark sample face features, i.e. face features extracted from the landmark sample photo, correspond to the face template features of the face template, and if the landmark depicted in the landmark sample photo correspond to a landmark template, the user may be authorized as the user with the registered account. Thereafter, the verification software 100 may switch to the second state 104 of the verification software.

The landmark template may be retrieved from a non-restrictive server. Put differently, since the landmark template cannot be used for identity theft, it is not required to have the same level of security for protecting this data compared to e.g. the face template.

Using landmark recognition in combination with face recognition, can, by way of example, be used if the sample photo is of a bad quality and as an effect that the comparison between the face sample features and face template features cannot be conducted reliably. Another reason may be if an account has been used in a suspicious way such that an extra security check is considered necessary. By using landmark recognition, an extra level of security is added to the authorizing step of the verification software.

In the second state 104 a second view of the verification software may be presented to the user. In the second state 104, the verification software can receive user input regarding actions the user wants to be performed, e.g. buying a product or service or making a reservation.

After having received inputs regarding the actions the user wants to have performed, the user may verify his or her identity by capturing additional sample information. This step may be considered as a second log in. If the additional sample information matches additional biometric template the verification software enters the third state 106.

In the third state 106 a third view of the verification software may be presented to the user. In the third state 106, the actions selected in the second state 104 can be performed, e.g. performing buying the product or service.

The third state 106 may be the state related to the highest security level. For the software to enter the third state 106, at least one identity verification between the first state 102 and the second state 104 may be performed, and at least one identity verification between the second state 104 and the third state 106 may be performed.

In summary, the user may perform at least two identity verifications to proceed to the third state 106 such that the selected actions are performed.

An advantage obtained, by using this verification software with multiple biometric verification, is that both the registration of a new account and using the registered account may be more secure compared to solutions only requiring single biometric verification. Further, by having a two stage biometric verification before any selected action is performed may make it more difficult for any person to pretend that he/she is someone else by, e.g., using a fake fingerprint or capturing a photo of a photo and not a real person.

Another advantage obtained, by using a verification software where the biometric verification is used when logging in is that the risk of performing selected actions using someone else's name may be reduced compared to other solutions. By way of example, it may be more difficult to perform online shopping using someone else's payment card. FIG. 2 is a flow chart generally illustrating an example of a method 200 for registering a new account of the user of the verification software by using the mobile device equipped with the camera and the display.

Generally, in a first step 202 of the method 200, a first image of a front side of a user's ID card may be captured, wherein the ID card may comprise text, which may comprise user information, and an ID photo depicting the user's face. In a second step 204, the user information and ID face features from the ID photo may be extracted. Thereafter, the user information may be presented 206 for the user on the display. In a fourth step 208, a reference photo of the user's face may be captured followed by extracting 210 reference face features from the reference photo. Thereafter, a comparison 212 between the reference face features and the ID face features can be performed, and if a match 214 is found, a face template can be formed 216 by using the reference face features. Alternatively, or in combination, the face template may be formed by using the ID face features. Alternatively, or in combination, the face template may be formed by using both the reference face features and the ID face features. The formed face template may then be stored 218 together with the user information.

By comparing reference face features and ID face features may contribute to a more secure registration than only linking the captured photo with the information extracted from the ID card. Further, by forming the face template, and storing the face template, instead of the reference photo, any further verification may be more precise since the method has extracted the interesting face features.

By way of example, in order to authenticate the account for face recognition log in, the identity of the user may be verified within a pre-set time period after the face template has been stored. The identity of the user may be verified by capturing a verification photo of the user's face by using the camera 110. Thereafter, verification face features may be extracted from the verification photo. The verification face features may be compared with the template face features of the face template. Upon a match is found, the account of the user may be authenticated for face recognition log in.

In order to reach an even more secure registration, a so called liveness step may be performed. The liveness step may comprise requesting the user to follow a graphical object with his/her eyes. The graphical object may be presented on the display 112. The graphical object may be moving according to a predetermined way. Eye movement imaging data depicting eye movement of the user may be captured. The eye movement image data may be compared with eye movement reference data. The eye movement reference data may be based on the predetermined way the graphical object may be moved. Upon the eye movement data corresponds to the eye movement reference data, the user may be identified as a real person and the liveness step may be fulfilled. By adding this step to the registration method, it is even more difficult for a user to fake the registration, e.g., to register a fake/stolen ID by capturing a photo of a photo. Thus, by requesting the user to follow the graphical object, the user must be a real person which can move his/her eyes.

The method 200 for registering a new account of the user may further comprise storing an additional biometric template. The additional biometric template may be created by capturing an additional verification information. The additional verification information may comprise biometrical information of the user by using the mobile device 108. Thereafter, additional biometric features may be extracted from the addition biometric information. An additional biometric template may be formed by using the additional biometric features. The additional biometric template may be stored together with the face template and the user information. The additional verification information may comprise fingerprint image data. Alternatively, or in combination, the additional verification information may comprise a voice sample of the user. By adding the additional biometric template to the face template and the user information may contribute to an even more secure verification software.

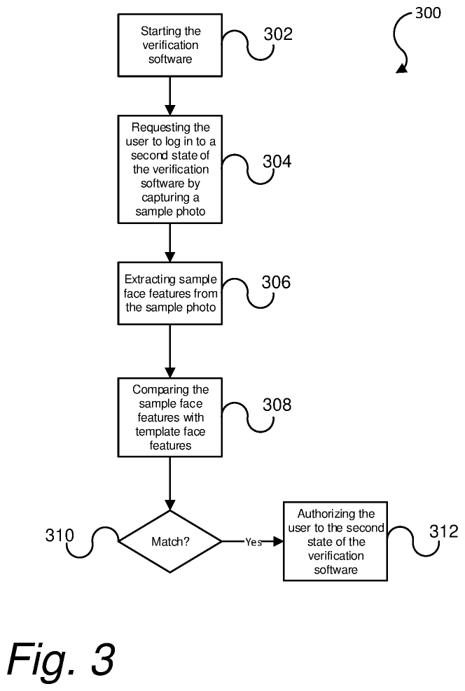

The user information may be stored on a cloud computer 508. Alternatively, or in combination, the face template may be stored on the cloud computer 508. Alternatively, or in combination, the additional biometric template may be stored on the cloud computer 508. Upon the user information and the face template may be stored on the cloud computer 508, the step of comparing the reference face features and the ID face features may be performed in the cloud computer 508. In FIG. 3, it is presented a flow chart illustrating a method 300 for using a registered account of a user of the verification software by way of example.

Generally, in a first step 302 of the method 300, the verification software may be started, and thereby setting the verification software in a first state. In a second step 304, the verification software may request the user to log in to a second state of the verification software. The login may be performed by capturing a sample photo of the user's face by using the mobile device equipped with the camera. Thereafter, the sample face features from the sample photo may be extracted 306. In a fourth step 308, the sample face features may be compared with template face features of a face template, and if a match 310 can be found, the user may be authorized 312 to the second state of the verification software. The step of comparing the sample face features with the template face features may be performed in the cloud computer 508. Upon the user may have entered the second state, different actions can be selected, such as putting items in a shopping bag.

In order for the user to perform selected actions, user inputs regarding actions to be performed may be received. Thereafter, the user may be requested to confirm the actions to be performed. The user may confirm the actions to be performed by capturing additional sample information of the user. The additional sample information may be compared with the additional biometric template. Upon a match is found, the selected action may be performed. By way of examples, the selected actions may be paying for the items in the shopping bag or transfer money to another account.

Hence, by analyzing the face features in a first log in state and then analyzing the additional biometric features in a second log in state may contributed to a more secure software verification without using any PIN code.

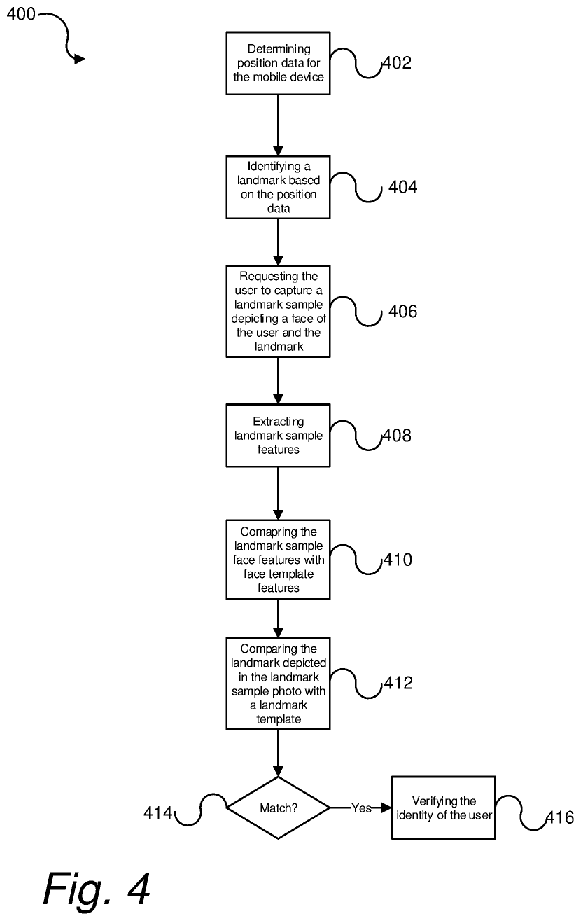

In FIG. 4, it is presented a flow chart illustrating a method 400 for verifying identity of the user of the verification software by using the mobile device equipped with the camera by way of example.

Generally, a first step 402 of the method 400 may be to determine position data for the mobile device. In a second step 404, a landmark may be identified based on the position data. Thereafter, the user may be requested 406 to capture a landmark sample photo which can depict a face of the user and the landmark. In a next step 408, landmark sample face features from the landmark sample photo may be extracted. In a fifth step 410, the landmark sample face features may be compared with the face template features of the face template, wherein the comparison may be performed in a first server. The first server may be a secure database comprising user information and face template. By a secure database it is meant a database wherein the information is private. There is no information leaving the secure database but only a “yes” or “no” upon the comparison is fulfilled or not. The comparison 410 between the face depicted in the sample and the face template may be based on activity data. In a sixth step 412, the landmark depicted in the landmark sample photo may be compared with a landmark template, wherein the comparison may be performed in a second server. The second server may be a non-restrictive server. By a non-restrictive server it is meant a server wherein the information is public. As a non-limiting example, the landmark template may be based on the time of the day. If two matches 414 are found, the identity of the user may be verified 416. The method 400 may further comprise determining weather conditions, GPS-coordinates, and the time of the day based on the position data.

An advantage obtained by using two different serves can be that the two different comparisons can be performed independently. Further, different security levels may be used for the different servers. Still further, information about landmarks may be shared by different users such that an extensive landmark database may be achieved quickly as well as stay relevant in an easy manner. Even further, landmark information may be imported from other services using landmark information.

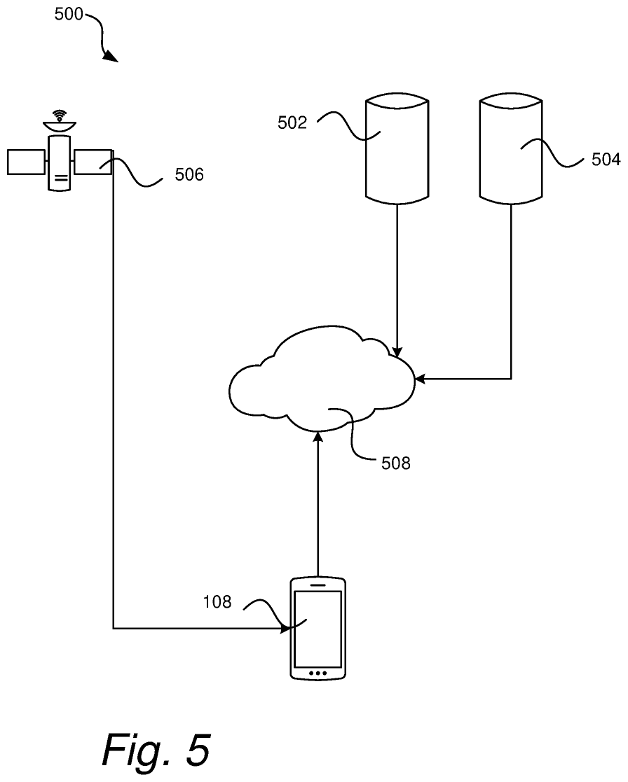

FIG. 5 generally illustrates a cloud computer environment 500. The cloud computer environment 500 may comprise the mobile device 108, a first server 502, a second server 504, a satellite 506 and a cloud computer 508.

The mobile device 108 may be used for capture samples of biometric features of a user, e.g. face features, fingerprint features or voice features. The mobile device 108 may also be used for presenting information to the user.

The first server 502 may be a secure server which can comprise user information and face templates. The user information and face templates relate to already registered accounts of the verification software.

The second server 504 may be a non-restricted server which can comprise landmark templates.

The satellite 506 can be used for providing position data to the mobile device 108 such that, in turn, the landmark template can be downloaded from the second server 504.

The cloud computer 508 may be configured to perform the comparisons between captured samples and templates.

An advantage obtained by using the cloud computer environment 500 is that the methods presented in FIG. 2-4 in full or in part may be performed in the cloud computer 508. Further, since none of the restricted user information, such the face template, may be handed out in a non-secure manner, using the cloud environment may provide for increased data security.

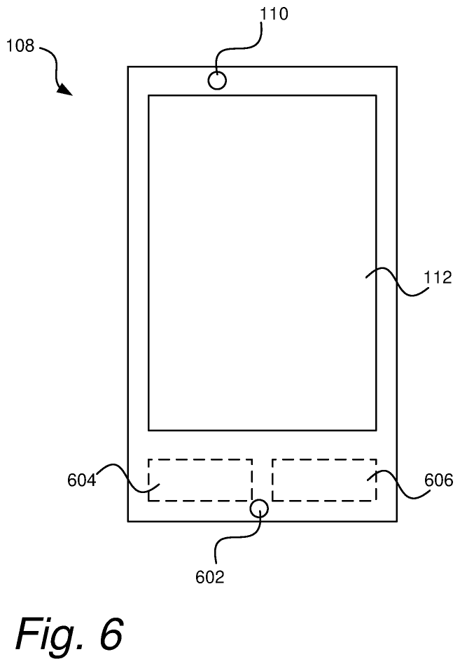

FIG. 6 generally illustrates a front view of the mobile device 108 in further detail. As illustrated in FIG. 1, the mobile device 108 may comprise a camera 110 and a display 112. Further, the mobile device 108 may also comprise a microphone 602, a memory 604, and a processor 606.

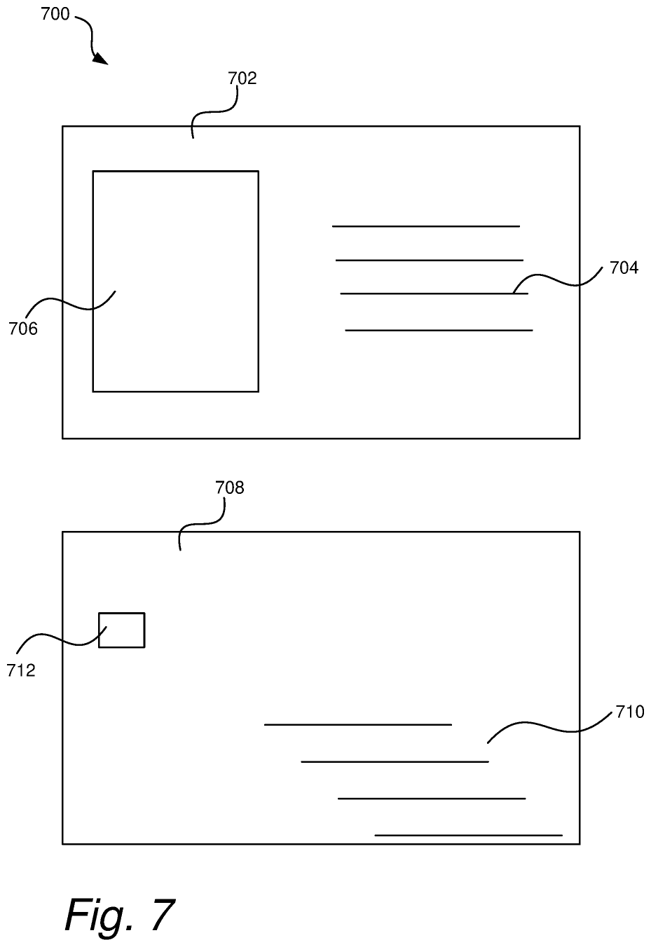

Referring to FIG. 7, the physical ID card 700 is illustrated. The physical ID card 700 may comprise a front side 702 and a back side 708.

The front side 702 may comprise text 704, which may comprise user information about the user to whom the physical ID card 700 has been issued, and a photo 706 depicting the user's face.

The back side 708 may comprise text 710 and a barcode 712. The barcode 712 may comprise user information which may be extracted by using a bar code reader software in the mobile device 108.

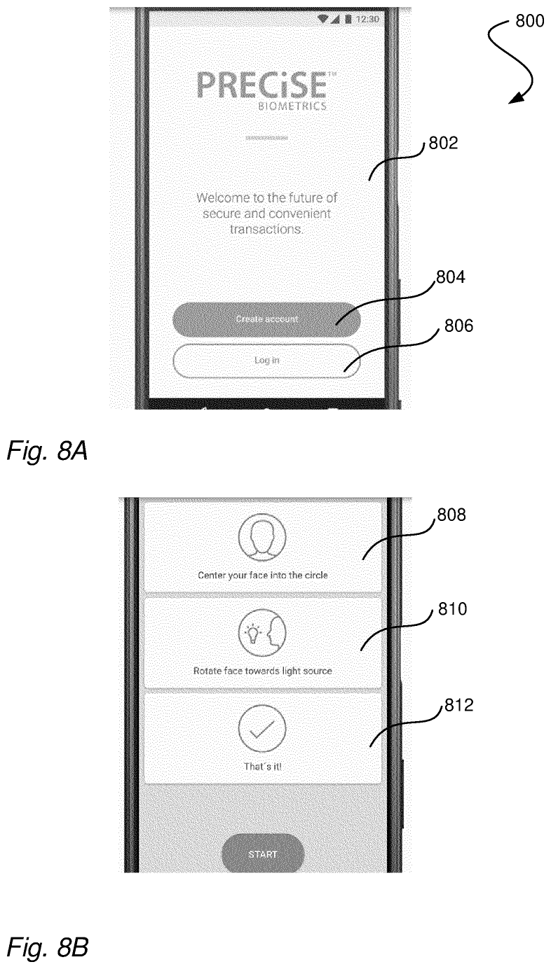

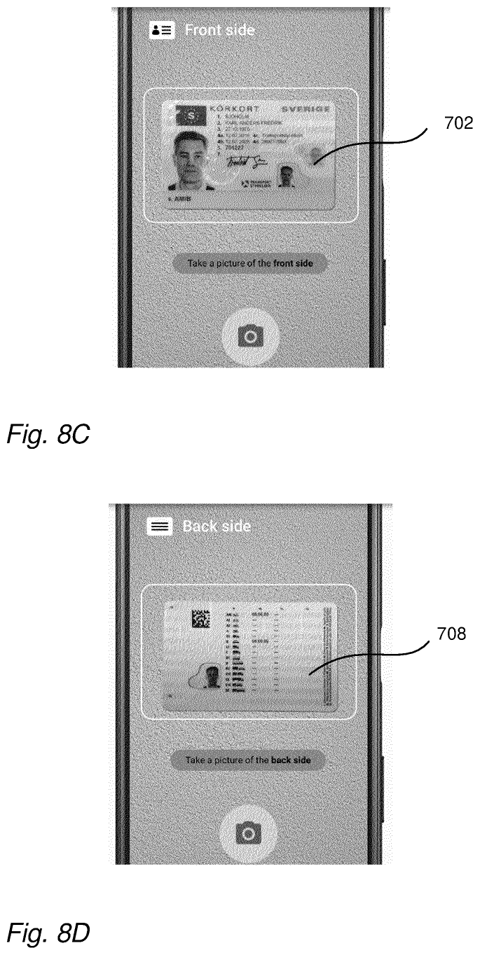

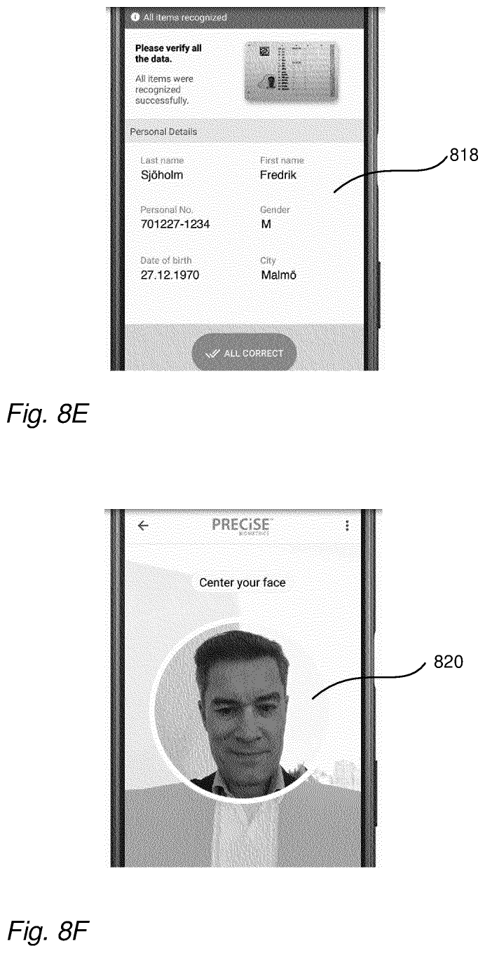

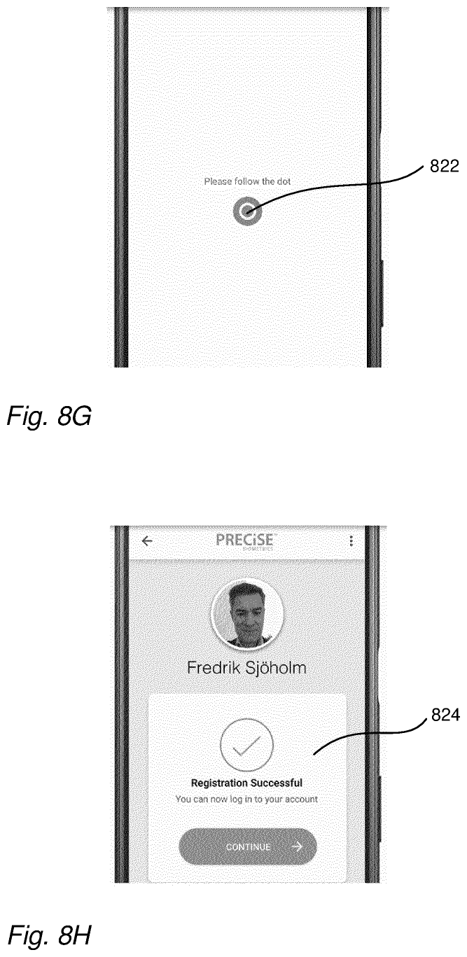

By way of example, FIG. 8a-h illustrates a step-by-step approach for registering a new account of a user of the verification software, e.g. according to the method 200 illustrated in FIG. 2.

In this particular example, with reference to FIG. 8a, a start view 802 of the verification software is presented on a display of a mobile device. This start view 802 may be presented on the display when the user opens the verification software. In the first view, it may be presented two different options 804, 806 for the user. The first option 804 may be creating an account; this option may be for a new user or for a user who wants to create another account for the verification software. The second option 806 may be to log in to the verification software; this option may be for a user who already have an account for the verification software.

With reference to FIG. 8b, a view of how the registration process of the verification software is to proceed is illustrated. This view of the verification software may occur when the user has chosen the option to create an account. This view may present information to the user about the steps the registration process such that the user is provided with a general understanding of the process.

According to a first step 808, the user is asked to center the face of the user into a circle (not shown in the figure, see FIG. 8f for example).

According to a second step 810, the user may be asked to follow a graphical object on the display. This step may be called a liveness step and is further illustrated in FIG. 8g.

According to a third step 812, the registration of the account may be completed.

Referring to FIGS. 8c and 8d, it is illustrated a mobile device, capturing a photo of a front side 814 and a back side 816 of the physical ID card, e.g. a driver's license. Further, it may be presented instructions to the user on the display. The instructions may comprise information about which side of the physical ID card that is to be captured, where the user is to place the physical ID card before capturing the picture of it and where on the display to tap when capturing the photo. The front side 814 of the physical ID card can comprise text, comprising user information, and a photo depicting the owner's face. The back side 816 of the physical ID card can comprise text and barcode.

Referring to FIG. 8e, it is illustrated an extracted user information view 818 presented on the display. The user may be informed if all the items have been recognized successfully or not. The user may have to confirm the information presented in the display.

FIG. 8f illustrates a face sample capturing view 820. In this view, the user may be asked to center his or her face within a presented geometry on the display. When the software has determined a position of the face provides for that the face features can be extracted, the user may capture a photo by using the camera.

In this example, the geometry presented on the display in this example is a circle, but it should be noted that this is just an example and any geometry is possible.

With reference to FIG. 8g, a liveness view 822, related to an optional step when registering a new account of a user of a verification software, is illustrated. To determine liveness, i.e. that the user is a real person, the graphical object may be moved on the display in a predetermined way. The user is asked to follow the moving graphical object 822 with his or her eyes. While the user is following the graphical object with his or her eyes, image data is captured by the camera. This image data is thereafter compared with data related to the predetermined way such that it can be verified that the eyes were moving in tune with the graphical object.

In FIG. 8h, it is illustrated a confirmation view 824 presenting that the registration of the new account was made successfully.

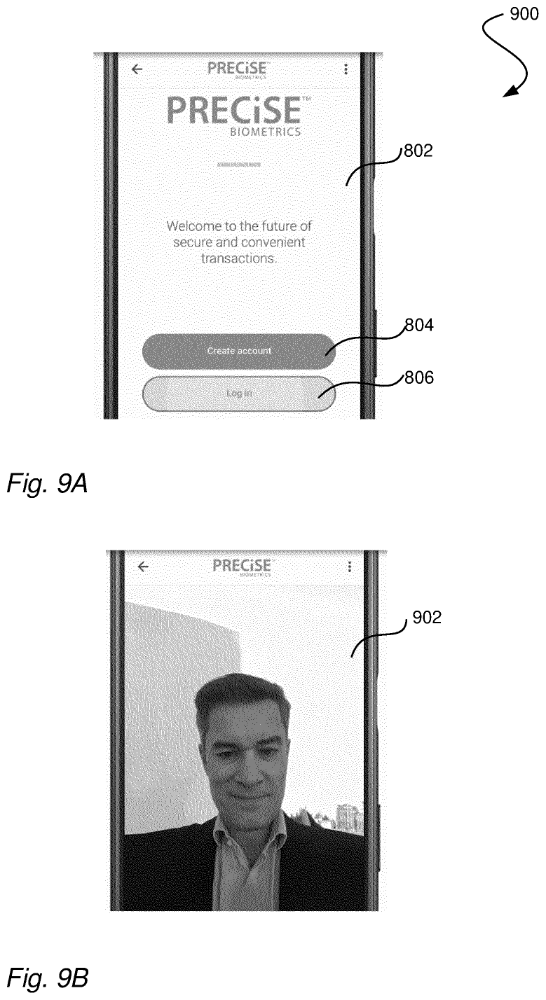

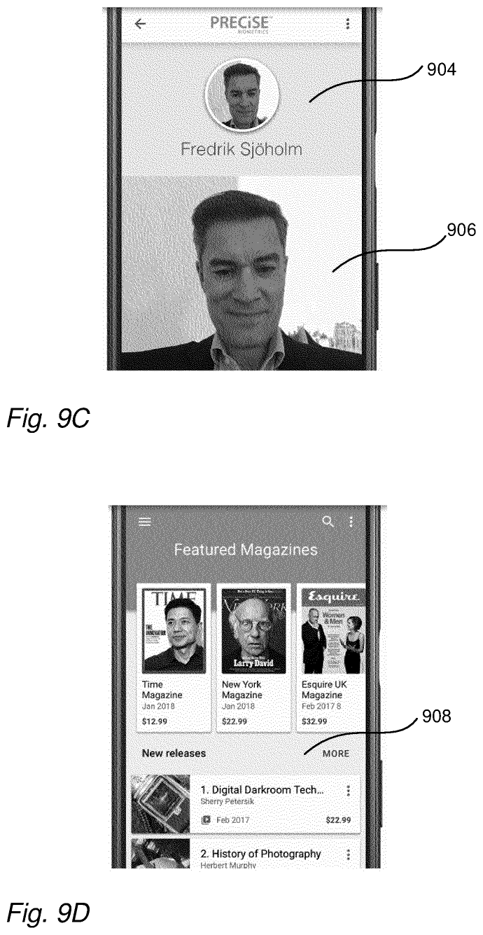

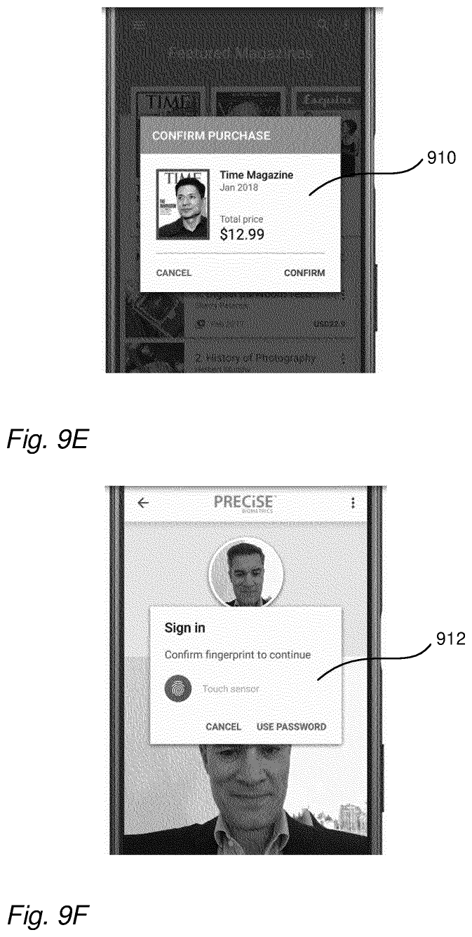

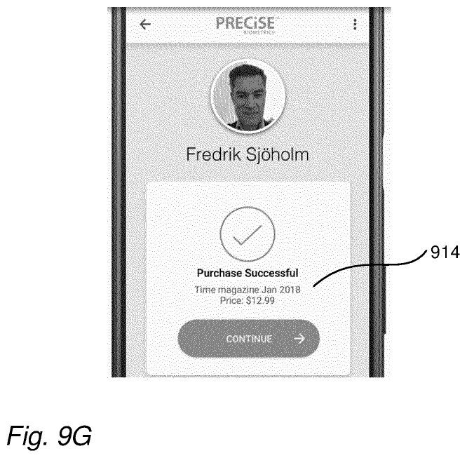

By way of example, FIG. 9a-g illustrates a step-by-step approach for using the registered account of the user of the verification software in line with the flow chart illustrated in FIG. 3.

FIG. 9a illustrates the start view 802 of the verification software as illustrated in FIG. 8a.

FIG. 9b illustrates a sample photo view 902 in which the user is to capture the sample photo of his face by using the camera of the mobile device.

With reference to FIG. 9c, it is illustrated an identification result view, in which two different photos of the user is presented. A photo on the lower half of the display may be the photo the user captured, with reference to FIG. 9b. On the upper half of the display, the name and reference photo for the user, based on the captured photo, may be presented.

FIG. 9d illustrates a first action selection view 908. In the illustrated example, a number of different magazines that the user can buy is presented.

FIG. 9e illustrates a second action selection view 910. By way of example, this view may present information to the user of the action that has been selected. In this example, a newspaper the user has chosen to buy is presented.

Referring to FIG. 9f, an additional biometric information input view 912 is illustrated. In this view, the user may be requested to confirm the selected actions by using a fingerprint recognition or voice recognition, by way of example.

Referring to FIG. 9g, an action performed view 914 may be illustrated. In this view, it may be illustrated that the confirmation of the selected actions has been successfully performed.

From the description above follows that, although various embodiments of the disclosure have been described and shown, the disclosure is not restricted thereto, but may also be embodied in other ways within the scope of the subject-matter defined in the following claims.

1. A method for registering a new account of a user of a verification software by using a mobile device equipped with a camera and a display, the method comprising:
capturing a first image of a front side of a physical ID card by using the camera, wherein the physical ID card comprises a text, comprising user information, and an ID photo depicting the user's face;
extracting the user information from the text and ID face features from the ID photo;
presenting the user information to the user on the display;
capturing a reference photo of the user's face by using the camera;
extracting reference face features from the reference photo;
comparing the reference face features and the ID face features;
if a match is found, forming a face template by using the reference face features; and
storing the face template together with the user information.

2. The method according to claim 1, further comprises:
verifying an identity of the user, within a pre-set time period after the face template has been stored, by capturing a verification photo of the user's face by using the camera;
extracting verification face features from the verification photo;
comparing the verification face features with template face features of the face template; and
if a match is found, authenticate the account for face recognition login.

3. The method according to claim 1, further comprising:
requesting the user to follow a graphical object with his or her eyes, presented on the display, wherein the graphical object is moving according to a predetermined way;
capturing eye movement image data depicting eye movements of the user;
comparing the eye movement image data with eye movement reference data based on the predetermined way the graphical object was moved; and
if the eye movement data correspond to the eye movement reference data, identifying the user as a real person.

4. The method according to claim 1, further comprising:
capturing an additional verification information comprising biometrical information of the user by using the mobile device;
extracting additional biometric features from the additional verification information;
forming an additional biometric template by using the additional biometric features; and
storing the additional biometric template together with the face template and the user information.

5. The method according to claim 4, wherein the additional verification information comprises fingerprint image data and/or a voice sample of the user.

6. The method according to claim 1, wherein the user information and the face template are stored in a cloud computer, wherein the step of comparing the reference face features and the ID face features is performed in the cloud computer.

7. A method for using a registered account of a user of a verification software, the method comprising:
starting the verification software, thereby setting the verification software in a first state;
requesting the user to log in to a second state of the verification software by capturing a sample photo of the user's face by using a camera of a mobile device;
extracting sample face features from the sample photo;
comparing the sample face features with template face features of a face template linked to the registered account;
if a match is found, authorizing the user to the second state of the verification software.

8. The method according to claim 7, wherein the face template is formed by:
capturing a first image of a front side of a physical ID card by using the camera, wherein the physical ID card comprises a text, comprising user information, and an ID photo depicting the user's face;
extracting the user information from the text and ID face features from the ID photo;
presenting the user information to the user on the display;
capturing a reference photo of the user's face by using the camera;
extracting reference face features from the reference photo;
comparing the reference face features and the ID face features; and
if a match is found, forming the face template by using the reference face features.

9. The method according to claim 8, further comprising:
receiving user input regarding actions to be performed;
requesting the user to confirm the actions to be performed;
capturing additional sample information of the user;
comparing the additional sample information with an additional biometric template; and
if a match is found, performing the selected actions.

10. The method according to claim 9, wherein the additional biometric template is formed by:
capturing an additional verification information comprising biometrical information of the user by using the mobile device;
extracting additional biometric features from the additional verification information; and
forming the additional biometric template by using the additional biometric features.

11. A method for verifying identity of a user of a verification software by using a mobile device equipped with a camera and a display, the method comprising:
determining position data for the mobile device;
identifying a landmark based on the position data;
requesting the user to capture a landmark sample photo depicting a face of the user and the landmark by using the camera;
extracting landmark sample face features from the landmark sample photo;
comparing the landmark sample face features with face template features of a face template, wherein the comparison is performed in a first server;
comparing the landmark depicted in the landmark sample photo with a landmark template, wherein the comparison is performed in a second server; and
if two matches are found, verifying the identity of the user.

12. The method according to claim 11, wherein the comparison between the face depicted in the sample and the face template is based on activity data.

13. The method according to claim 11, wherein the first server is a secure database comprising user information and face templates.

14. The method according to claim 11, further comprising determining weather conditions, GPS-coordinates and the time of the day, based on the position data.

15. A mobile device comprising:
a camera configured to capture a sample of biometric features of a user;
a display configured to present information for the user;
a microphone configured to capture a sample of voice features of the user;
a memory holding template features coupled to a template for the user, wherein the template is an image of a biometric sample of an authorized user, text, comprising user information of the authorized user, and a photo depicting the authorized user's face;
a processor configured to extract sample features from the sample, retrieve the template features from the memory, compare the sample features with the template features, and if a match between the sample features and the template features is found, accepting a login to a verification software for the authorized user.
